(19) United States
(12) Patent Application Publication
(10) Pub. No.: US 2011/0088300 A1
(43) Pub. Date: Apr. 21, 2011

(54) DEPLOYABLE ADVERTISING MEDIUM FORMED BY A PLANE PANEL

(75) Inventor: Raul Santiago Martin Presa, Arganda del Rey (Madrid) (ES)

(73) Assignee: SERIGRAFIA MARGI, S.L., Arganda del Rey (ES)

(21) Appl. No.: 12/989,505

(22) PCT Filed: Apr. 26, 2007
(86) PCT No.: PCT/ES2007/070083

§ 371 Date: Oct. 25, 2010

(51) Int. Cl. G09F 15/00; G09F 1/06

(52) U.S. Cl. 40/606.12; 40/610

(57) ABSTRACT

Advertising display unit formed by a flat blank adhering in the interior spaced defined by two advertising blanks which are equal and adhering to each other by means of tabs arranged along its length, where the flat formation blank is divided into three sections with two ends equal and one central, provided on the upper and lower edges of the end sections with notches for housing elastic means for the folding out and retention in folded position, where, due to the simplicity of the formation blank, the total width of the display stand when it is folded out may be simply defined, and place in relation the width of the advertising blanks in order to achieve the desired concavity, thus enabling definition of a unit with a circular support base.

### OBJECT OF THE INVENTION

The object of this invention is a folding advertising display unit which when folded out retains its position without any additional means of retention.

The advertising display unit which is the object of this invention comprises two advertising blanks which carry the information to be shown, arranged with their borders or edges joined in such a way that they define an interior space, inside which adhere flat sheets with a formation arrangement which permit folding out and formation of the display unit in such a way that the display unit is free standing and remains retained in said position.

The display unit has the particularity of being able to remain folded, while once the component modules have been folded out and the edges or ends of the arrangement have been joined, the die-cut formation blanks arranged in its interior adopt a position which provides it with an elliptical or circular form in section, so that its lower edge serves as a support for the advertising display unit.

The present invention is characterised in particular by the special configuration and design of all the blanks which make up the advertising display unit, and specifically the flat die-cut formation blanks arranged in the interior space defined by the advertising blanks carrying the information. As a result of the design of all the blanks in the arrangement, an advertising display unit is obtained which folds out and is retained automatically.

Therefore, the present invention is circumscribed by the scope of folding advertising display units.

### BACKGROUND TO THE INVENTION

At the present date there are numerous folding advertising display units which are provided with elastic arrangements which facilitate their folding out, such as the display unit indicated in patent no. WO 2002095719.

The advertising display unit shown in this patent shows, among other particularities, that of a single blank display surface for presenting the information, and specifying in addition a posterior panel fixed to the remainder of the unit which, in collaboration with elastic means, bends the display face.

The present invention now aims to overcome the disadvantages of the folding out display unit shown in patent WO 2002095719, by developing a unit in which both surfaces are able to present information, the means of folding out are arranged in its interior and are not visible from the outside.

Other advertising display units comprise complex die-cut blanks which serve to automatically fold out and maintain the unit in a displayed position, and these are complicated in both design and manufacture.

In addition it is not possible to construct an advertising display adapted to the needs of the client where, among other elements, it is possible to choose, in addition to height of the display unit once it is folded out, the width thereof, as well as the desired concavity for the advertising display blanks.

Therefore, the object of the present invention is to develop an advertising display unit which overcomes previous disadvantages, and which uses for its folding out and retention a formation blank with a simple design, and in which as a result of its design it is possible to adapt to the client's support parameter requirements such as the width or concavity desired for the advertising blanks.

### DESCRIPTION OF THE INVENTION

The present invention of an advertising display unit which folds out basically consists of an advertising blank on which the information to be displayed is presented on both sides, with said blank having on its end edges flaps for adhering, used to adhere the blanks along their length so that a closed continuous surface is defined.

The advertising display unit, like other such units, comprises a series of modules joined together by means of a fold line so that one module can be folded on another.

In the interior space defined by the advertising blank and on each one of the component modules adhering to their interior, is a flat formation blank which enables the folding out and subsequent retention of the advertising unit once it has been folded out.

The folding out of the unit is achieved by folding out or extending the component modules, once the unit has been folded out and, due to the configuration of the flat formation blank and the form it takes, it is possible to maintain the unit in a folded out position. In order to fold, all that is required is a slight pressure on the die-cut formation blank so that it relinquishes its previous position.

The flat formation blank contains the essential nature of the invention, permitting it to be folded out and maintained in a folded out position, in addition to the fact that due to its simplicity it is possible to determine the dimensions it should have in order to ensure, once it has been folded out, that the display unit has a specific width.

In addition, taking into account the dimensions and the flat formation blank it is possible to select the width of the blanks carrying the advertising according to the desired concavity which the unit adopts when folded out.

Specifically said formation blank is provided with a general rectangular form, the surface of which is divided into three sections or portions separated by vertical perforated lines. The two end sections are the same and the central section differs.

The upper and lower edges of the end sections of the flat formation blank are provided with notches in which elastic means are housed which implement the folding out and keep the advertising display unit in a folded out position.

The elastic means try to join the two end sections of the flat formation blank against the fold of the central section, thus, the width adopted by the display unit once it has folded out is the same as the sum of the length of the end sections minus the central section.

Furthermore the width which the blanks carrying the advertising should show should be between a length greater than the width of the unit, since if it were the same, the unit would not adopt an elliptical configuration and therefore it would not stand alone, and a width of (2*π*R)/2 where:

R=half the width which the display unit would adopt when folded out

This value (2*π*R)/2 would be the width that the blanks carrying the advertising should have in order to adopt a general circular form once they are folded out.

In order to fold out the advertising display unit, firstly, all the modules comprising the unit are folded out, and subsequently the elastic means approach the end sections of the flat formation blank, forming the display unit with a curved surface on both faces.

In order to fold the unit, a slight pressure is exercised on the sides of each of the modules and in the area in which the formation arrangements adhere, so that the end sections of the flat formation blank are separated against the force of the elastic means so that each module is left almost flat and in a position of automatic non-folding out, if beforehand a slight force has not been exercised on the lateral sides of the support.

The flat formation blank does not necessarily need to make use of all the modules of the advertising display unit, thus, in a unit with three modules it may make use of the end modules and not the central one, nor is it necessary for the height of each of the flat formation blanks to be the same as the height of each of the modules.

### DESCRIPTION OF THE DRAWINGS

In order to complement the description which follows, and to provide a better understanding of the characteristics of the invention, the present descriptive report is accompanied by a set of drawings which represent the most significant details of the invention in an illustrative manner but one which is in no way restrictive.

FIG. 1 shows a perspective view of the advertising display unit when folded out showing the flat formation blanks in its interior.

FIG. 2 shows the form of the formation blank of the advertising display unit.

FIG. 3 shows the form of each of the blanks carrying the advertising.

FIG. 4 shows a perspective diagram of the display unit formed with an external circular configuration.

### PREFERRED EMBODIMENT OF THE INVENTION

In the light of the figures a preferred embodiment of the invention proposed is described below.

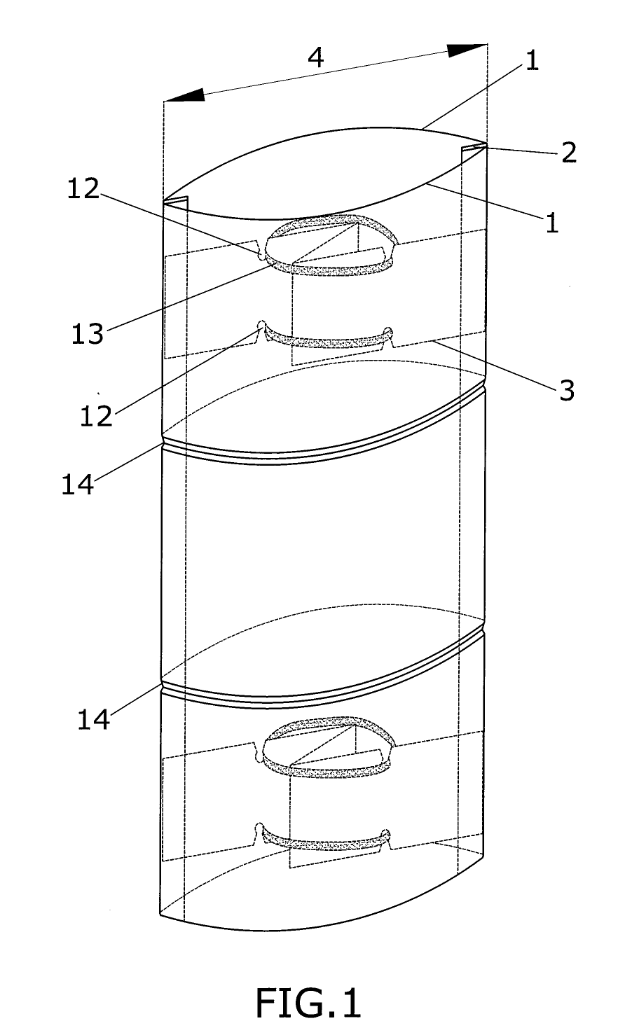

FIG. 1 shows the advertising display unit folded out and retained in said position, formed by two equal blanks (1), carrying the advertising separated in modules by means of fold lines (14).

Each of the blanks is provided on their lateral edges and along the whole length with end flaps (2) for affixing said blanks (1) to each other

In the interior a flat formation blank (3) adheres to the flaps (2) which enables the unit to be folded out using elastic means (13) housed in notches (12) made on the upper and lower edges of the blanks (1) in their end sections.

The advertising unit has a width (4) when folded out which is defined by the dimensions of the flat formation blanks (1).

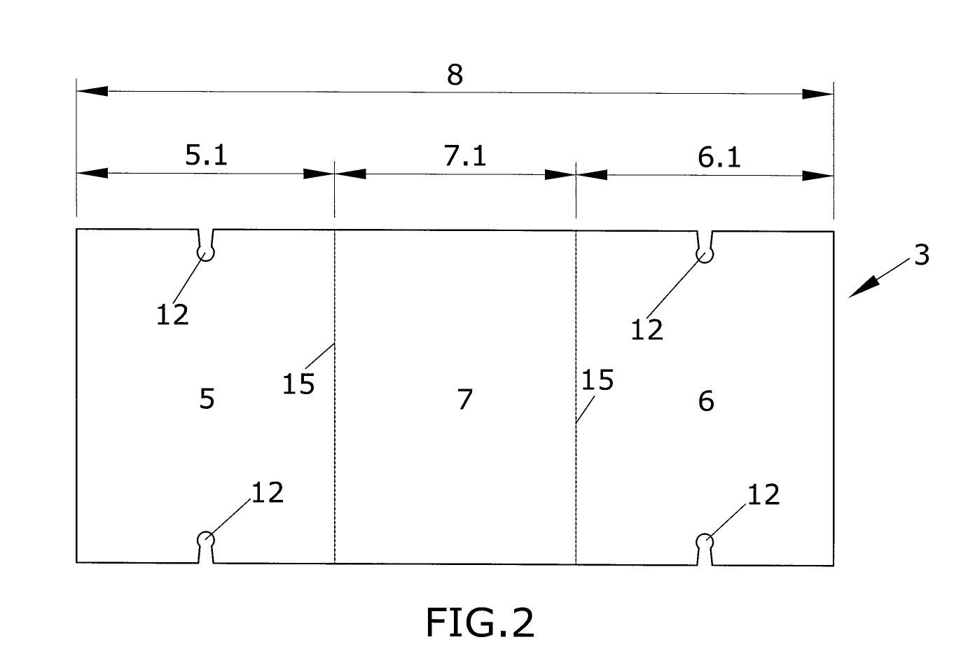

Thus in FIG. 2 we note how each of the formation blanks are divided into three sections, two ends (6) and a central section (5) with the end sections (6) being equal to each other.

The width of the end sections (5) and (6) is respectively (5.1) and (6.1) whereas the width of the central section (7) is (7.1) so that the sum of the lengths (5.1) (6.1) and (7.1) provides a length (8) which is the total length presented by the formation blank (1).

Despite the important dimension which is that which should be taken into account for dimensions of the formation blank(1) it is the total width (4) desired for the advertising display unit once it is folded out, thus the total width (4) shall be equal to the width (5.1) and (6.1) minus the width (7.1) of the central section (7).

We also note in FIG. 2 that the end sections (5) and (6) on their upper and lower edges are provided with notches(12) in which the elastic means which shape the display unit are housed. Said notches (12) are arranged at a distance from the fold line (15) between sections equal to the width of the central section (7).

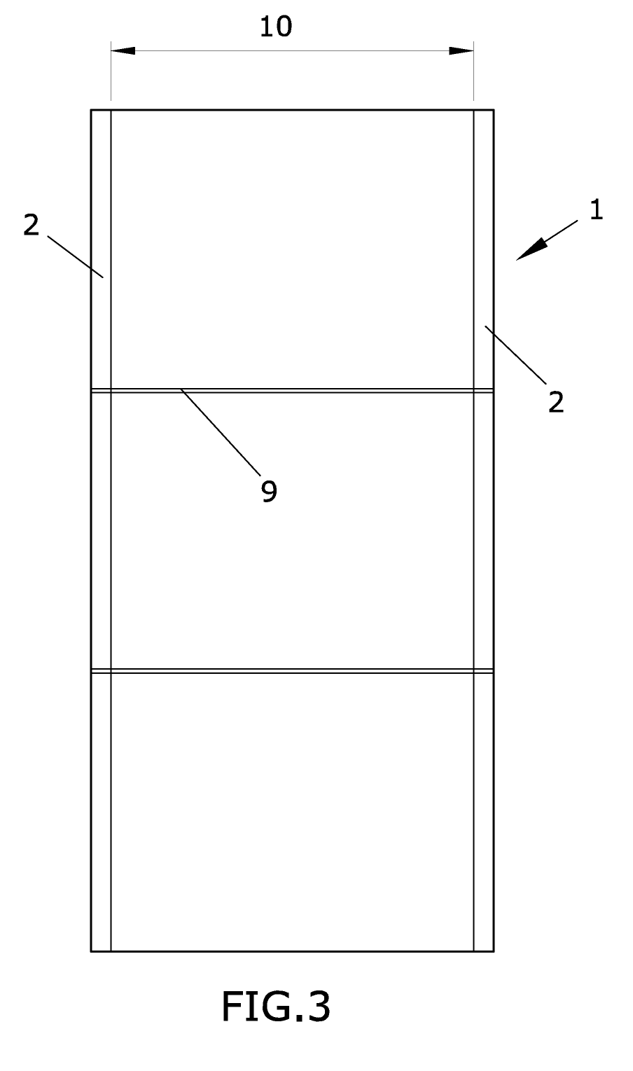

Furthermore, FIG. 3 shows the configuration of the advertising carrying blanks (1) which are provided on their edges along the whole length with flaps (2) for adhering interrupted by fold lines (9).

The width or distance (10) between the flaps (2) of each blank (1) should be such that it exceeds the width (4) of the unit once it has been folded out so that it may form a support surface which is at least elliptical.

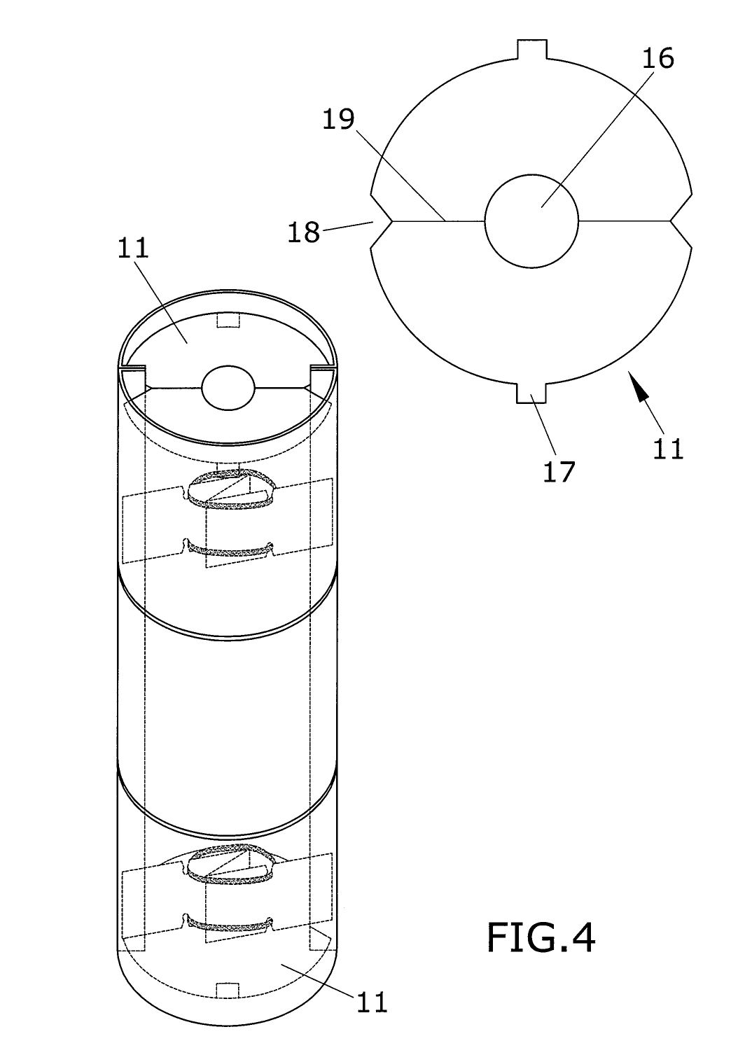

FIG. 4 shows a folded out advertising display unit with a circular support surface for which the width (10) between the flaps (2) of each blank should be equal to:(2*π*R)/2, where R=half the width (4) which the unit would have when folded out.

A reasonable dimension for the width (10) of the blanks (1) could be equal to (2*π*R)/3, which permits an elliptical configuration of the support surface.

In addition to this circular configuration of the support surface of the advertising display unit, an additional reinforcement blank (11) is added which forms a circular outline.

FIG. 5, shows the details of said reinforcement blank (11) separated into two parts by a fold line (19) the ends of which are provided with notches (18) which enables the adherence flaps (2) to be housed.

In addition, the edges are provided with tabs (17) for adhering to the interior of the blanks (1) carrying the advertising.

The essential nature of this invention is not altered by variations in materials, form, shape and arrangement of the component elements, which are described in a manner which is in no way restrictive but which is sufficient for an expert to proceed to its reproduction.

1. Fold out advertising display unit formed by a flat blank which is provided with: octagonal form and is provided with:
two blanks (1) carrying the advertising and the ends of which along their length are provided with adherence flaps (2).
A flat formation blank (3) adhered to the interior of the blanks (1) carrying the advertising.
Elastic means for folding out and retaining the folded out position.
Characterised in that:
The flat formation blank (3) is divided into three sections, two ends (5) and (6) of the same width and a central one (7), so that the sum of the width (5.1) and (6.1) of the end sections (5) and (6), minus the width (7.1) of the central section (7) is equal to the width (4) of the advertising display unit when it is folded out.

2. Folding advertising display unit formed by means of a flat blank, according to claim 1, characterised in that the width (10) between the adherence flaps (2) of each blank (1) carrying the advertising should be greater than the final width (4) desired for the advertising display unit and less than (2*π*R)/2 where
R=half the width which the display unit would adopt when folded out.
In this situation it would adopt an external circular configuration.

3. Folding advertising display unit formed by means of a flat blank according to claim 2 characterised in that the width (10) between the adherence flaps (2) of each blank (1) carrying the advertising is equal to 2*π*R)/3.

4. Folding advertising unit formed by means of flat blank according to claim 3 or 4, characterised in that the flat formation blanks (1) present on their upper and lower edges, in the end sections (5) and (6), notches (12) for housing elastic means (13).

5. Folding advertising display stand formed by means of a flat blank according to claim 4, characterised in that the notches (12) are arranged at a distance from the fold line (15) between sections equal to the width of the central section (7).

6. Folding advertising display stand formed by means of a flat blank according to claim 2, characterised in that the width (10) between the adherence flaps (2) of each blank (1) carrying the advertising is equal to (2*π*R)/2.

7. Folding advertising display stand formed by means of a flat blank according to claim 6, characterised in that the reinforcement blank (11) presents a central circle (16) separated into two parts by a fold line(19) at the ends of which there are two notches (18) which provide housing for the adherence flaps (2), in addition it is provided on its edges with tabs (17) for adhering to the interior of the blanks (1) carrying the advertising.
